(19) United States
(12) Patent Application Publication
(10) Pub. No.: US 2014/0290709 A1
(43) Pub. Date: Oct. 2, 2014

(54) SHOCK ABSORBING CRUTCH TIP AND METHOD OF MANUFACTURE

(71) Applicant: Marshall Aaron Vaughn Basham, Auckland Central (NZ)

(72) Inventor: Marshall Aaron Vaughn Basham, Auckland Central (NZ)

(21) Appl. No.: 14/240,869

(22) PCT Filed: Aug. 29, 2012
(86) PCT No.: PCT/NZ2012/000150

§ 371 Date: Jun. 6, 2014

(30) Foreign Application Priority Data
Aug. 30, 2011 (NZ) 594882

(51) Int. Cl. A61H 3/02; B29C 45/16

(52) U.S. Cl. CPC A61H 3/0288; B29C 45/1671; B29C 45/1676; B29C 2045/1673
USPC 135/82; 264/255

(57) ABSTRACT

The invention provides a moulded crutch tip in addition to a method of manufacturing such a crutch tip. This method preferably uses a mould which defines a single continuous volume which in turn defines an upper region, and a lower region. A crutch tip is formed by closing off the upper or the lower region of the volume with at least one blank structure, and then introducing a first mouldable material into the remaining open region of the mould. This blank structure is then removed from the previously closed volume and then a second mouldable material is introduced into the mould. In some embodiments this manufacturing method may be fully automated.

### FIELD OF THE INVENTION

The present invention relates to a shock absorbing crutch tip structure. This crutch tip structure can be used to terminate the ground contacting end of a shaft of a walking aid.

### BACKGROUND OF THE INVENTION

Walking aids improve the mobility of a large number of people. Walking aids such as canes, elbow crutches, axilia (underarm) crutches, walking frames or Zimmer frames have all been developed to provide additional support to those with impaired mobility.

These aids always incorporate one or more shafts which a user puts their weight on as they walk. The end of such a shaft is normally terminated with a soft pliable tip, commonly known as a crutch tip. As a user walks forward the crutch tip contacts the ground, increasingly grip or purchase with the the ground, while also protecting indoor floor surfaces from damage.

Crutch tips also act as a shock absorbing mechanism, cushioning the force transmitted from contact of the tip to the ground through to a user's hands, elbow or armpits. This shock absorbing property is a valuable and sought after characteristic of crutch tips. Walking aids used by those recovering from injuries or ailments benefit from this shock absorbing effect which limits aggravation of the user's condition during recovering. The long-term disabled also rely on walking aids to provide improved mobility as part of daily life. For long term users of walking aids, the shock absorbing effect of crutch tips is important to mitigate painful repetitive jarring and fatigue experienced with the extended use of a walking aid.

Crutch tips are normally formed of synthetic rubber or similar forms of pliable elastomeric polymer materials. The most commonly used forms of prior art crutch tips are moulded from a single piece of material with a consistent hardness or pliability characteristic. With these existing forms of crutch tip a trade-off is required between the softness of material used to increase shock absorbing character and the ability of this material stand up to the continuous wear and tear of multiple impacts against the ground. In particular, crutch tips made from overly soft pliable materials will have a short life span and will need to be replaced frequently.

One attempt to address these issues in the prior art is disclosed in US patent application US 2005/0129456 to Van Der Sluis. This specification discloses a modification made to a crutch or walking stick to integrate a physical shock absorbing mechanism within the crutch shaft. Although this type of apparatus does go some way towards providing a shock absorbing effect to a walking aid, its implementation is relatively complicated and the crutch provided is expensive to manufacture. Furthermore, a user is unable to retrofit or modify their existing walking aids if they wish to use this technology. The shock absorbing mechanism disclosed may not necessarily be required on some more forgiving surfaces, but in all cases will add to the weight of the walking aid which needs to be carried everywhere by a user.

Other attempts to improve on existing crutch tips are disclosed in US patents, U.S. Pat. No. 4,881,564, U.S. Pat. No. 5,178,176 and U.S. Pat. No. 5,826,606. These patents disclose a number of similar implementations of a crutch tip with a shock absorbing inner core. This core is formed from an air pocket or a gel or shock absorbing pad installed within a cavity formed in the interior of a crutch tip. Although these devices can improve the shock absorbing capabilities of a crutch tip while maintaining its hard wearing character, they are relatively complicated components to manufacture. In particular, a large amount of manual assembly work is required to introduce all the individual separate parts required, and to ensure that all these components are correctly sited and aligned with each other to ensure the tip will function correctly. These requirements can make these crutch tips expensive to construct and also relatively slow to manufacture, while requiring a relatively large labour force to complete manual assembly work.

It would therefore be of advantage to have an improved crutch tip or similar tip system for the terminating end of a walking aid shaft which addressed any or all of the above problems. In particular, it would be of advantage to have a crutch tip which could be applied to a wide range of existing walking aids, which exhibited an effective shock absorbing capability, and also had a hard wearing character. Furthermore it would also be of advantage to have an improved crutch tip which could be manufactured with a minimum of parts, with a minimum of—or potentially no—manual labour quickly and at relatively low cost. At the least it would be of advantage to have a crutch tip which provided the public with an alternative choice.

### DISCLOSURE OF THE INVENTION

According to one aspect of the invention there is provided a method of manufacturing a moulded crutch tip arranged to engage with the end of a shaft of a walking aid, said method being characterised by the steps of:
a. providing a mould defining a single continuous volume, said single continuous volume defining an upper region, and a lower region, and
b. closing off the upper or the lower region of the volume with at least one blank structure, and
c. introducing a first mouldable material into the remaining open region of the mould, and
d. removing said at least one blank structure from the mould, and
e. introducing a second mouldable material into the mould.

According to another aspect of the invention there is provided a moulded crutch tip arranged to engage with the end of a shaft of a walking aid, the moulded crutch tip including
an upper shock absorbing portion formed from a pliable mouldable material, and
a lower wear foot formed from a durable mouldable material,
   whereby the mouldable material forming the lower wear foot is harder than the mouldable material forming the upper shock absorbing portion.

According to a further aspect of the invention there is provided a walking aid which includes at least one shaft terminated by a moulded crutch tip, said moulded crutch tip including an upper shock absorbing portion formed from a pliable mouldable material, and a lower wear foot formed from a durable mouldable material, whereby the mouldable material forming the lower wear foot is harder than the mouldable material forming the upper shock absorbing portion

The present invention is adapted to provide both a method of manufacturing moulded crutch tip, in addition to a crutch tip formed by this manufacturing method, and a walking aid which incorporates one or more of these crutch tips. Reference in general throughout this specification will be made to the present invention therefore providing crutch tips which form a terminating foot or ferrule for a walking aid. Those skilled in the art will appreciate that the term “crutch tip” should therefore not be seen as limiting or an indication that the invention has utility only in respect of crutches. The invention may be used with a wide range of walking aids—such as for example walking frames, or a variety of different walking sticks, in addition to crutches.

The present invention is arranged to provide a moulded crutch tip. The invention uses a mould in this manufacturing process which may be implemented in a number of ways in various embodiments.

For example, in one embodiment a mould used by the invention may be formed by a number of mould elements or components which are moved together to define a volume.

These mould elements when moved together may also co-operate with additional structures such as blank structures, closing wedges and/or various projecting bodies to close at least a portion of the volume defined by the mould elements and allow a crutch tip to be moulded.

However, in a preferred embodiment a mould may be formed from a single component which co-operates with a variety of blank structures, closing wedges and/or projecting bodies to close at least a portion of the volume defined by the mould and allow a crutch tip to be moulded.

Reference in general throughout this specification will be made to the mould used being formed from a single component. Again however those skilled in the art should appreciate that other implementations of a mould are also within the scope of the invention.

The mould used by the invention defines a single continuous volume which will ultimately be occupied by a crutch tip formed at the end of the moulding process. This single volume may be composed from or defined as incorporating and upper region and a lower region. Those skilled in the art will appreciate that the terms upper and lower are applied arbitrarily irrespective of the actual orientation of the mould during the moulding process. Furthermore, such a mould may be formed by a block of material which defines a number of such moulds, all of which individually define a single continuous volume.

Preferably the upper region defined by the mould may be arranged to form an upper shock absorbing portion in any resulting crutch tip.

Preferably the lower region defined by the mould may be arranged to form a lower wear foot in any resulting crutch tip. Preferably this lower wear foot may have a hardwearing long lifespan character.

This upper shock absorbing portion may be arranged to engage with the terminating end of the shaft of a walking aid, while the lower wear foot may be arranged in use to contact the ground as a user employs a walking aid.

Preferably the method of manufacture provided by the invention incorporates steps where a mouldable material is introduced into the mould. The mould provided also co-operates with at least one blank structure in at least one of these moulding steps to close off a region of the interior volume defined by the mould. The use of such a blank structure prevents mouldable material from entering the closed off region, and therefore allows a portion only of the crutch tip to be moulded within the remaining open region of the mould. After this portion of the crutch tip has been moulded any blank structure or structures used may then be removed to expose the original volume of the mould, which at this stage is partially filled with the injected mouldable material.

In a preferred embodiment a coolant may be circulated adjacent to the introduced mouldable material after a moulding step. The circulation of coolant within, on or adjacent to a mould is a well-known process in the art and promotes faster setting or hardening of heated liquid mouldable materials.

Once one region of the mould has been filled with a mouldable material and any blank used is with drawn from the mould, a further moulding step may be completed to introduce a second mouldable material into the remaining open volume of the mould. In a preferred embodiment at least one blank structure may be used during this second moulding step to seal or fully enclose the remaining open volume of the mould. Those skilled in the art will appreciate that in some instances the same blank structure may be used at this stage as was used in the first moulding step—or alternatively additional blank structures may be employed with this second moulding step.

In a preferred embodiment, after this second mouldable material is introduced the entire crutch tip required will have been formed. However, those skilled in the art should appreciate that more complicated moulds may be used and crutch tips may also be formed with additional moulding steps in other embodiments. References made above to the use of two moulding steps or stages only should in no way be seen as limiting.

Those skilled in the art will also appreciate that the order in which the upper or the lower regions of the mould are closed may be varied arbitrarily in different embodiments. For example in one embodiment mouldable material may be introduced in to the lower region before the upper region, whereas in other embodiments the reverse situation may occur.

In a preferred embodiment mouldable materials may be introduced into interior of the mould through an injection process. Injection moulding techniques are well known in the art and may be utilised in conjunction with the present invention.

The manufacturing method provided by the invention employs at least two different forms of mouldable material. In a preferred embodiment only a first mouldable material and a second mouldable material are employed. Again however, those skilled in the art should appreciate that more complicated forms of crutch tip may be moulded in accordance with other embodiments.

These different mouldable materials are selected for the different hardness or pliability characteristics which they exhibit. The upper region of the mould used to form an upper shock absorbing portion is injected with a mouldable material which has a greater shock absorbing or a softer character than the mouldable material injected into the lower region used to form the lower wear foot of the crutch tip.

In a preferred embodiment the mouldable material used to form the upper shock absorbing portion may be defined or described as a pliable mouldable material. A pliable mouldable material may be softer or more pliable than the material used to form the lower wear foot of the crutch tip.

In a preferred embodiment the pliable mouldable material may exhibit a Shore A hardness value ranging from 40 to 69. Materials with these values of Shore A hardness are capable of exhibiting the shock absorbing characteristics required of the resulting upper shock absorbing portion.

In a further preferred embodiment the material of the upper shock absorbing portion may have a Shore A hardness value ranging from 40 to 55.

In a preferred embodiment the mouldable material used to form the lower wear foot may be defined or described as a durable mouldable material. A durable mouldable material may be harder or more durable than the material used to form the upper shock absorbing portion.

In a further preferred embodiment the durable mouldable material may exhibit a Shore A hardness value ranging from 70 to 85. Materials with these values of Shore A hardness are capable of exhibiting the hard wearing character required of the resulting wear foot.

In a preferred embodiment both the pliable and durable mouldable materials may be formed from the same compound with different amounts of filler material added to each to provide the resulting pliable or durable characteristics. By using mouldable materials with similar compositions a strong bond can be provided by the moulding process between the upper and lower sections of the crutch tip.

In a further preferred embodiment the compound selected as a base for such a mouldable material may be a self-adhesive silicone, thermoplastic urethane or similar compound. However those skilled in art will obviously appreciate that other base compounds may be used in conjunction with the present invention in respect of mouldable materials and referenced to the above only should in no way be seen as limiting.

This softness or shock absorbing character of the upper shock absorbing portion allows the crutch tip to function effectively as a shock absorbing element to a walking aid. The provision of a harder more durable wear foot on the same crutch tip also mitigates wear problems, providing a shock absorbing crutch tip which is unlikely to wear out quickly due to the durable hard nature of the lower wear foot.

In a preferred embodiment the upper shock absorbing portion defines an upper exterior surface for the resulting crutch tip, and the lower wear foot defines a lower exterior surface for the crutch tip. In a further preferred embodiment the entire exterior surface of the crutch to may be defined only by the upper shock absorbing portion and lower wear foot.

The present invention may therefore provide a crutch tip formed within a single moulding process with a soft or pliable upper shock absorbing portion and a lower comparatively hard wearing foot. This arrangement therefore allows the upper shock absorbing portion to present at least a portion (and preferably all) of the upper exterior surface of the crutch tip, and the lower wear foot to form preferably all of the lower exterior surface of the crutch tip.

In a preferred embodiment the materials selected to form the upper shock absorbing portion and lower wear foot may be adhered together during this moulding process through the action of heat and vulcanisation. This approach greatly simplifies the manufacturing process, allowing a fully formed finished crutch tip to be removed from the mould without the need for an additional manual adhesive application or assembly steps.

In a preferred embodiment a portion of the mould or a further separate blank structure may be used as or may define a tread blank. A tread blank may be used in the moulding step which forms the lower wear foot of the crutch tip to form a tread pattern in the bottom surface of the lower wear foot. In a further preferred embodiment the tread blank may impart a tread pattern which defines an outer ring combined with inner rings and/or cleats. This form of tread pattern can provide the resulting crutch tip with additional purchase and traction when used with a walking aid. Those skilled in the art will appreciate that the specific implementation of such a tread blank (as either part of the mould or a separate blank structure) will depend on the arrangement of the mould and any other blank structures used in conjunction with same.

In a preferred embodiment a portion of the mould or a further separate blank structure may be used as or may define a socket blank. A socket blank may be used in the moulding step which forms the upper shock absorbing portion of the crutch tip to form a socket which can receive the terminal end of a walking aid shaft. This socket can therefore allow the crutch tip to be installed on the end of a walking aid shaft without the need for any additional fastening components or the use of attachment tools. Those skilled in the art will appreciate that the specific implementation of such a socket blank (as either part of the mould or a separate blank structure) will depend on the arrangement of the mould and any other blank structures used in conjunction with same.

In a further preferred embodiment a socket blank may be arranged to form or define an array of ribs, or corrugated projections or depressions in the socket formed within the upper shock absorbing portion. Preferably this array of ribs or similar features may extend longitudinally down the axis of the socket and provide an engagement mechanism for the end of any walking aid shaft pushed into the socket. These features may therefore improve the frictional engagement between the end of a shaft and the socket, thereby allowing a walking aid to be connected to the crutch without any additional fasteners or requiring the use of any tools.

In a preferred embodiment the manufacturing method provided also includes the step of introducing a washer structure into the upper region of the mould before the introduction of a mouldable material into said upper region. In a further preferred embodiment the washer may be introduced into the upper region adjacent to a socket blank. A washer structure may preferably provide a flat metallic surface which is arranged to abut the end of a walking aid shaft introduced into the socket formed in the upper shock absorbing portion. By introducing such a washer structure into the upper before the introduction of the mouldable material, this washer structure is permanently adhered to the upper shock absorbing portion by the moulding process.

In a preferred embodiment a socket blank may be formed by a locating projection used to introduce a washer into the upper region of the mould. A washer may be connected attached otherwise held in place in the end of this locating projection, with the body the projection forming the blank structure and staying inside the mould as mouldable material is subsequently introduced. After the upper shock absorbing portion has been moulded the washer may then be released from this locating projection and the locating projection removed from the mould to leave the washer moulded into and as part of the bottom of the socket formed in the upper shock absorbing portion.

In a further preferred embodiment a locating projection may exhibit magnetic properties allowing a magnetically sensitive washer to be held in place on the end of this locating projection during the moulding process.

The present invention may provide many potential advantages over the prior art.

In a preferred embodiment the invention provides a foot for a walking aid with varying shore harnesses' moulded into the one piece and thus a low cost of manufacture—leading towards a low cost but effective end product. The upper portion of the crutch tip that receives the walking aid shaft is of a lower Shore hardness rating giving the crutch tip a soft dampening effect, while moulded into the same tip where it contacts the ground is an elastomer of a higher Shore hardness rating, thereby slowing the wear or deterioration of the tip. The movement or action during use is a compressive force causing displacement within the elastomer. This provides a damper or shock absorbing effect which then returns to its original compression set when the force is removed.

### BRIEF DESCRIPTION OF THE DRAWINGS

Additional and further aspects of the present invention will be apparent to the reader from the following description of embodiments, given in by way of example only, with reference to the accompanying drawings in which:

FIGS. 1a, 1b show perspective and side cross section views of a crutch tip provided in accordance with one embodiment of the invention, and

FIGS. 2a -2d show cross section views of a mould and the content of the mould during a method of manufacturing a crutch tip in accordance with a further embodiment, and

FIGS. 3a - 3d show cross section views of a mould and the content of the mould during a method of manufacturing a crutch tip in accordance with an additional embodiment of the invention.

Further aspects of the invention will become apparent from the following description of the invention which is given by way of example only of particular embodiments.

### BEST MODES FOR CARRYING OUT THE INVENTION

The invention can provide a crutch or walking stick tip or foot that can retro-fit onto existing or newly manufactured crutches, canes or walking sticks whereby the tip is the part of the crutch that contacts the ground. The invention includes a method of manufacture of the shock absorbing crutch tip which can use composite material thermal injection machinery. This machinery can allow two or more different composite materials to be injected in unison either simultaneously or in stages before a coolant hardens the composite material to form one solid product

This invention can employ two or more pliable elastomer materials such as but not limited to self-adhesive silicones designed to bond to thermo plastic substrate surfaces. In preferred embodiments these materials do not require the use of primers and special thermoplastic tooling that accommodate heated and cooled sections with crisp shut offs for moulding a thermoplastic and thermoset material into a one piece crutch tip that fits onto the end of most standard sized aluminium tubing crutches. The thermal injection mould tooling can operate on a 3-dimensional xyz axis so that the upper portion of the crutch tip cavity has a soft elastomer material injected into the mould after which a wedge or blank structure that occupied the lower portion of the crutch tip preventing thermal elastomer injection moves outwards. This allows for a separate gate that injects a harder elastomer material where the ground contacts the crutch tip.

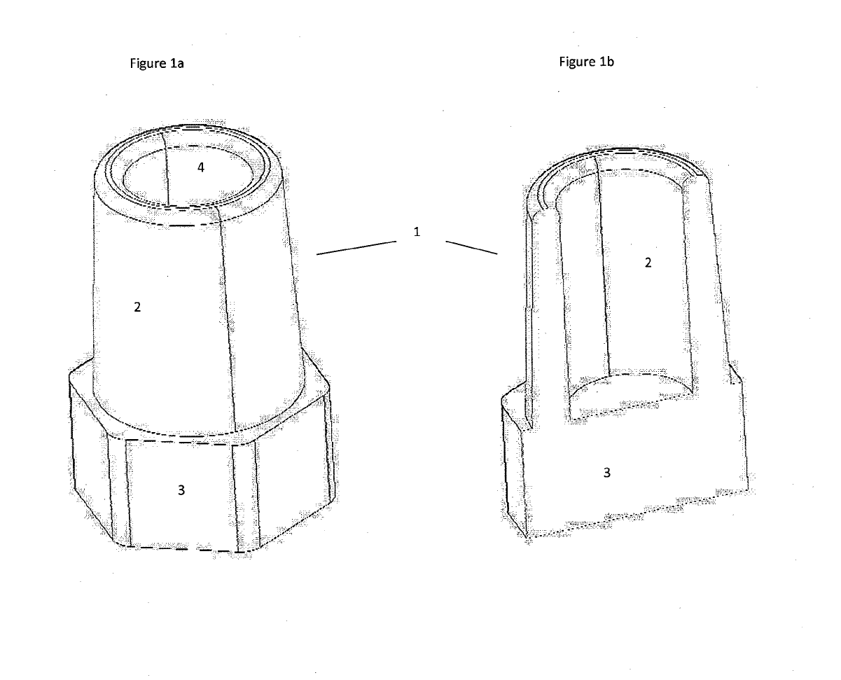

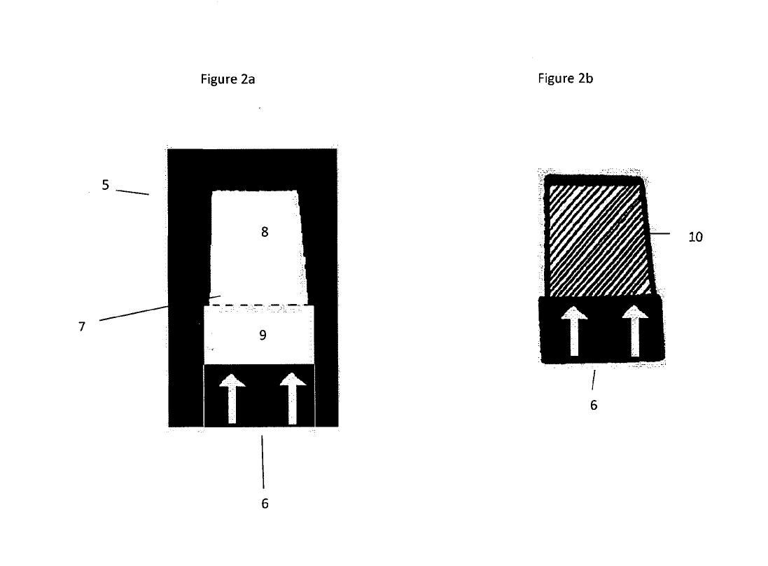

FIGS. 1a, 1b show perspective and side cross section views of a crutch tip provided in accordance with one embodiment of the invention.

These figures show a crutch tip 1 formed in a single moulding process. This crutch tip defines an upper shock absorbing portion 2, and a lower wear foot 3. As can also be seen from these figures the upper shock absorbing portion 2 also defines or provides a socket 4 capable of receiving and retaining the end of a walking aid shaft (not shown).

The upper shock absorbing portion 2 is moulded entirely from a pliable mouldable material, while the lower wear foot 3 is moulded entirely from a durable mouldable material. This combination provides a shock absorbing effect in combination with a hard wearing long life crutch tip.

The crutch tip 1 is formed only from the upper shock absorbing portion 2 and the lower wear foot 3. The upper shock absorbing portion 2 therefore defines or provides the entire upper exterior surface of the crutch tip, and the lower wear foot provides the entire lower exterior surface of the crutch tip.

In some embodiments crutch tip provided by the invention also incorporates a washer element (not shown) moulded integrally into the base of the socket 4 provided within the upper shock absorbing element 2. This washer element can provide a mating surface for the terminal end of a walking aid shaft.

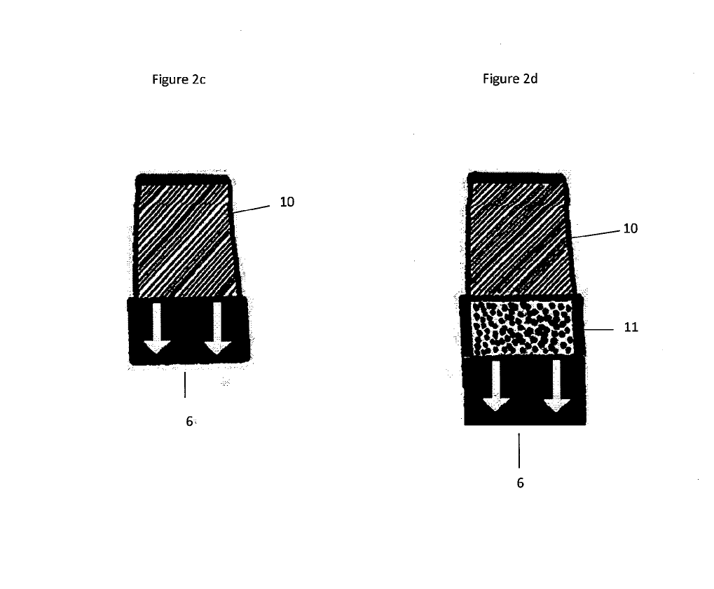

FIGS. 2a -2d show cross section views of a mould and its content during a method of manufacturing a crutch tip in accordance with a further embodiment.

FIG. 2a shows a mould 5 and an associated blank element 6 at the start of the manufacturing process. As can be seen from this figure the mould defines a single continuous volume 7 made up of an upper region 8 and a lower region 9. For the sake of clarity the mould 5 is not shown in FIGS. 2b- 2d

FIG. 2b shows the content of the mould once a first mouldable material 10 has been injected into the upper region 8. To facilitate this step the blank element 6 has been moved up into the lower region 9 to close off the lower region and prevent any of the injected mouldable material 10 entering the lower region.

FIG. 2c shows the content of the mould after this first moulding step during a cooling phase. At this stage of the manufacturing process a coolant fluid (not shown) is circulated around the upper region 8 of the mould, after which the blank element 6 is withdrawn from the lower region 9.

FIG. 2d shows the content of the mould once a second mouldable material 11 has been injected into the lower region 9. The blank element 6 is used to close off and seal the remaining open face of the lower region 9 to allow a hot pressurised second mouldable material 11 be injected into this region.

FIG. 2d therefore illustrates a finished crutch tip formed only from the first and second mouldable materials 10, 11 by a single or common moulding process.

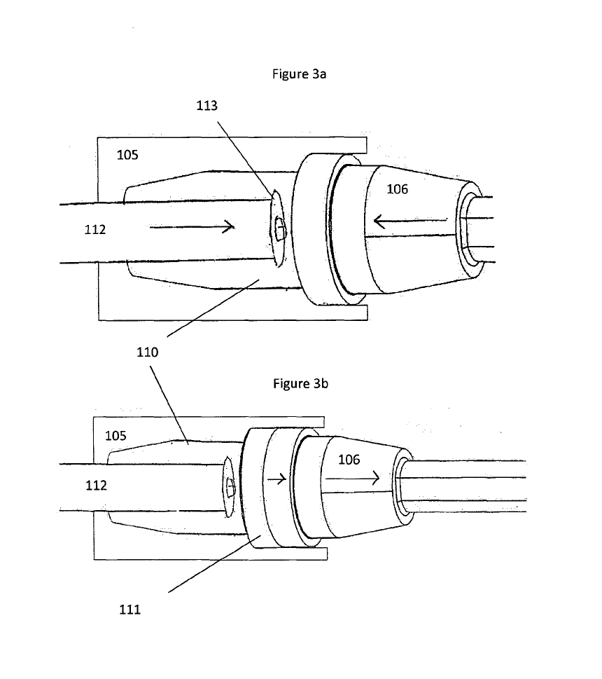

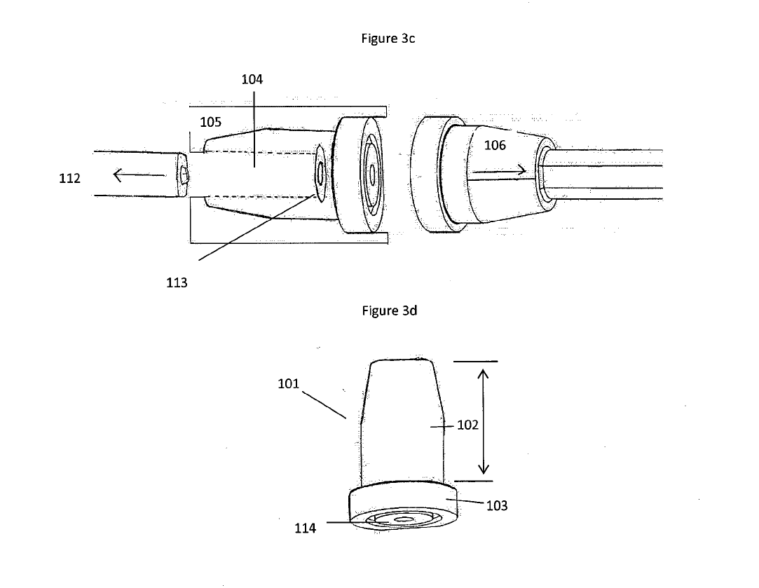

FIGS. 3a -3d show cross section views of a mould and the content of the mould during a method of manufacturing a crutch tip in accordance with an additional embodiment of the invention.

FIG. 3a shows the first moulding step of this manufacturing process. A mould 105 is provided which has its lower region closed off by a blank element, provided in this embodiment by a tread blank 106. The upper region of the mould 105 also accommodates a socket blank, formed in this embodiment by a locating projection 112 used to introduce a washer 113 into the interior volume of the mould 105.

In the situation shown in FIG. 3a a first mouldable material has been introduced into the upper region of the mould 105, where in this embodiment the first mouldable material is pliable synthetic rubber 110. At this stage none of the pliable synthetic rubber 110 can move through to the lower region of the mould 105 because of the blocking effect of the tread blank 106.

FIG. 3b shows the second moulding step of this manufacturing process. At this stage the tread blank 106 is moved out of the lower region of the mould 105 and a second mouldable material is injected into the lower region on top of and in contact with the pliable synthetic rubber 110 already in the upper region of the mould. At this stage the lower region of the mould is filled with a durable synthetic rubber 111.

FIG. 3c shows the condition of the mould after a coolant fluid (not shown) has been circulated around the exterior of the mould. At this stage both the tread blank 106 and locating projection 112 are removed from the interior of the mould. The removal of the locating projection 112 exposes a socket 104 formed in the resulting crutch tip 101. The removal of the locating projection 112 also leaves within the bottom of the socket 104 the washer 113 previously located by the projection 112. This washer 113 acts as a base plate to the end of a walking aid shaft inserted into the socket 104.

As indicated above FIG. 3d illustrates a fully formed finished crutch tip 101 as provided by this manufacturing process. The crutch tip includes an upper shock absorbing portion 102 formed entirely from pliable synthetic rubber and which also defines a socket 104. The crutch tip also includes a lower wear foot 103 which has a tread pattern 114 formed in its base which is provided by the action of the tread blank 106.

As can be seen from these figures the crutch tip 101 is formed solely by the pliable synthetic rubber 110 and durable synthetic rubber 111 in combination with a single washer 113. The upper shock absorbing portion 102 forms the upper exterior surface area of the crutch tip 101, and the lower wear foot 103 forms the lower exterior surface of the crutch tip.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A method of manufacturing a moulded crutch tip arranged to engage with the end of a shaft of a walking aid, said method being characterised by the steps of: a. providing a mould defining a single continuous volume, said single continuous volume defining an upper region, and a lower region, and b. closing off the upper or the lower region of the volume with at least one blank structure, and
c. introducing a first mouldable material into the remaining open region of the mould, and
d. removing said at least one blank structure from the mould, and e. introducing a second mouldable material into the mould.

2. A method of manufacturing a moulded crutch tip as claimed in claim 1 wherein the mould defines or receives a socket blank within the upper region.

3. A method of manufacturing a moulded crutch tip as claimed in claim 1 wherein the mould defines or receives a tread blank within the lower region.

4. A method of manufacturing a moulded crutch tip as claimed in claim 1, said method including the additional step of introducing a washer structure into the upper region before the introduction of a mouldable material into said upper region.

5. A method of manufacturing a moulded crutch tip as claimed in claim 4, wherein the washer is introduced into the upper region adjacent to a socket blank.

6. A method of manufacturing a moulded crutch tip as claimed in claim 1, wherein the first mouldable fluid material sets as a solid when cooled, and the second mouldable fluid material sets as a solid when cooled, each solid material exhibiting different degrees of hardness.

7. A method of manufacturing a moulded crutch tip as claimed in claim 6, wherein in the mouldable fluid material introduced into the lower region sets as a solid exhibiting a higher degree of hardness than the mouldable material introduced into the upper region.

8. A method of manufacturing a moulded crutch tip as claimed in claim 1 wherein the material of the upper shock absorbing portion has a Shore A hardness value ranging from 40 to 69.

9. A method of manufacturing a moulded crutch tip as claimed in claim 8 wherein the material of the upper shock absorbing portion has a Shore A hardness value ranging from 40 to 55.

10. A method of manufacturing a moulded crutch tip as claimed in claim 1, wherein the material of the lower wear foot has a Shore A hardness value ranging from 70 to 85.

11. A method of manufacturing a moulded crutch tip as claimed in claim 1 wherein the first mouldable material and the second mouldable material are injected into the mould.

12. A moulded crutch tip arranged to engage with the end of a shaft of a walking aid, the moulded crutch tip including
an upper shock absorbing portion formed from a pliable mouldable material, and
a lower wear foot formed from a durable mouldable material,
whereby the mouldable material forming the lower wear foot is harder than the mouldable material forming the upper shock absorbing portion.

13. A moulded crutch tip as claimed in claim 12 wherein the upper shock absorbing portion defines a socket capable of receiving and locating the end of a shaft of a walking aid.

14. A moulded crutch tip as claimed in claim 12 or claim 13 wherein in the upper shock absorbing portion and lower foot are formed and adhered together in a single moulding process.

15. A moulded crutch tip as claimed in claim 14 wherein a single injection moulding process forms the upper shock absorbing portion and lower foot.

16. A moulded crutch tip as claimed in claim 12 wherein the upper shock absorbing portion defines an upper exterior surface of the crutch tip and the lower foot defines a lower exterior surface of the crutch tip.

17. A moulded crutch tip as claimed in claim 12 wherein the material of the upper shock absorbing portion has a Shore A hardness value ranging from 40 to 69.

18. A moulded crutch tip as claimed in claim 17 wherein the material of the upper shock absorbing portion has a Shore A hardness value ranging from 40 to 55.

19. A moulded crutch tip as claimed in claim 12 wherein the material of the lower wear foot has a Shore A hardness value ranging from 70 to 85.

20. A walking aid which includes at least one shaft terminated by a moulded crutch tip, said moulded crutch tip including an upper shock absorbing portion formed from a pliable mouldable material, and
a lower wear foot formed from a durable mouldable material, whereby the mouldable material forming the lower wear foot is harder than the mouldable material forming the upper shock absorbing portion

21. A walking aid as claimed in claim 20, wherein the upper shock absorbing portion defines a socket which receives and locates the end of a shaft of a walking aid.

22. A walking aid as claimed in claim 20 wherein the upper shock absorbing portion defines an upper exterior surface of the tip and the lower fault defines a lower exterior surface of the tip.
